(19) United States
(12) Patent Application Publication
(10) Pub. No.: US 2024/0411546 A1
(43) Pub. Date: Dec. 12, 2024

(54) VEHICLE CONTROL APPARATUS

(71) Applicant: Mitsubishi Electric Corporation, Tokyo (JP)

(72) Inventors: Nozomi YAMADA, Tokyo (JP); Takuya KONO, Tokyo (JP); Akihiro SANADA, Tokyo (JP)

(73) Assignee: Mitsubishi Electric Corporation, Tokyo (JP)

(21) Appl. No.: 18/698,136

(22) PCT Filed: Nov. 9, 2021
(86) PCT No.: PCT/JP2021/041088

§ 371 Date: Apr. 3, 2024

(51) Int. Cl. G06F 8/65

(52) U.S. Cl. CPC G06F 8/65

(57) ABSTRACT

The objective of the present disclosure is to obtain a vehicle control apparatus that executes updating of high-priority software so as to prevent a vehicle from abnormally operating and that makes it possible to perform software updating that provides no adverse effect to the behavior of the vehicle. The electric rotating machine apparatus includes
the computing processing unit,
a storage apparatus in which software items are written,
a priority reading unit that reads a priority of software,
a reception unit that receives updating software,
an updating-feasibility determination unit that determines that updating is feasible, in the case where the priority for software is larger than a predetermined priority threshold value, and
a software updating unit that transfers the updating software to the storage apparatus, in the case where it is determined that updating is feasible.

### TECHNICAL FIELD

The present disclosure relates to a vehicle control apparatus.

### BACKGROUND ART

In recent years, software updating for a vehicle control apparatus that utilizes OTA (over-the-air) technology has been adopted in the automobile industry. OTA technology signifies transmission/reception of data by use of wireless communication. In particular, OTA often means data communication for updating its own OS (Operating System) or installed application software of a wireless communication terminal represented by a smartphone.

There has been proposed an apparatus that stably executes updating of software for a vehicle control apparatus by use of OTA technology. There has been proposed a software updating method in accordance with a power-on/off state of a vehicle and a delivery planning of a vehicle (for example, Patent Document 1).

### CITATION LIST

### Patent Literature

Patent Document 1: Japanese Patent Application Laid-Open No. 2021-81779

### SUMMARY OF INVENTION

### Technical Problem

In a technology disclosed in Patent Document 1, when software for a vehicle control apparatus is updated, an execution requirement is notified to a vehicle master apparatus. After that, when the requirement is satisfied, the software updating is executed. The foregoing method makes it possible that in a stable environment, software updating utilizing OTA technology is executed.

However, in the technology in Patent Document 1, the priorities of software items to be updated are not considered. Accordingly, even when feasibility determination on software updating is performed based on a vehicle state, updating of software with a high priority may be postponed and hence an adverse effect may be provided to the behavior of a vehicle control apparatus. Moreover, there is also presumed the case where the updating frequency of low-priority software is raised and hence the load on a computing processing unit becomes large.

The present disclosure has been implemented in order to solve these problems. The objective thereof is to obtain a vehicle control apparatus that executes updating of high-priority software so as to prevent a vehicle from abnormally operating, in the case where software items of a computing processing unit mounted in the vehicle are updated, and that makes it possible to perform software updating that provides no adverse effect to the behavior of the vehicle.

### Solution to Problem

A vehicle control apparatus according to the present disclosure includes
a computing processing unit,
a storage apparatus in which software items to be executed by the computing processing unit are written,
a priority reading unit that reads a priority of software to be executed by the computing processing unit,
a reception unit that receives updating software that updates software to be executed by the computing processing unit,
an updating-feasibility determination unit that reads, from the priority reading unit, a priority for software to be updated by the updating software received by the reception unit and that determines that updating is feasible, in the case where the priority is larger than a predetermined priority threshold value, and
a software updating unit that transfers the updating software to the storage apparatus, in the case where the updating-feasibility determination unit determines that updating is feasible.

### Advantageous Effects of Invention

In the case where software items for the computing processing unit are updated, the vehicle control apparatus according to the present disclosure determines the feasibility of software updating, based on the priority set for each of the software items. As a result, it is made possible that updating of high-priority software is executed so as to prevent a vehicle from abnormally operating and hence software updating that provides no adverse effect to the behavior of the vehicle is performed.

### BRIEF DESCRIPTION OF DRAWINGS

FIG. 1 is a schematic configuration diagram of a vehicle control apparatus according to Embodiment 1;

FIG. 2 is a hardware configuration diagram of any one of a master control apparatus, a connection control apparatus, and a server of the vehicle control apparatus according to Embodiment 1;

FIG. 3 is a diagram representing the connection in the vehicle control apparatus according to Embodiment 1;

FIG. 4 is a functional block diagram of the master control apparatus in the vehicle control apparatus according to Embodiment 1;

FIG. 5 is a functional block diagram of a first connection control apparatus in the vehicle control apparatus according to Embodiment 1;

FIG. 6 is a first software configuration diagram of the first connection control apparatus in the vehicle control apparatus according to Embodiment 1;

FIG. 7 is a second software configuration diagram of the first connection control apparatus in the vehicle control apparatus according to Embodiment 1;

FIG. 8 is a third software configuration diagram of the first connection control apparatus in the vehicle control apparatus according to Embodiment 1;

FIG. 9 is a table for explaining the combination of updating-feasibility determinations at the time of software updating according to Embodiment 1;

FIG. 10 is a flowchart representing processing by the master control apparatus in the vehicle control apparatus according to Embodiment 1;

FIG. 11 is a flowchart representing processing by the connection control apparatus in the vehicle control apparatus according to Embodiment 1;

FIG. 12 is a first flowchart representing data-corresponding processing in the vehicle control apparatus according to Embodiment 1;

FIG. 13 is a second flowchart representing data-corresponding processing in the vehicle control apparatus according to Embodiment 1;

FIG. 14 is a table for explaining the relationship between common data and reference software at the time of software updating according to Embodiment 1;

FIG. 15 is a table for explaining priority management at the time of software updating according to Embodiment 1;

FIG. 16 is a functional block diagram of the master control apparatus in a vehicle control apparatus according to Embodiment 2;

FIG. 17 is a functional block diagram of a first connection control apparatus in the vehicle control apparatus according to Embodiment 2;

FIG. 18 is a first flowchart representing data-corresponding processing in the vehicle control apparatus according to Embodiment 2;

FIG. 19 is a functional block diagram of a master control apparatus in a vehicle control apparatus according to Embodiment 3;

FIG. 20 is a flowchart representing processing by the master control apparatus in the vehicle control apparatus according to Embodiment 3;

FIG. 21 is a functional block diagram of a master control apparatus in a vehicle control apparatus according to Embodiment 4; and

FIG. 22 is a flowchart representing processing by the master control apparatus in the vehicle control apparatus according to Embodiment 4.

### DESCRIPTION OF EMBODIMENTS

Hereinafter, vehicle control apparatuses according to Embodiments of the present disclosure will be explained with reference to the drawings.

### 1. Embodiment 1

### <Configuration of Vehicle Control Apparatus>

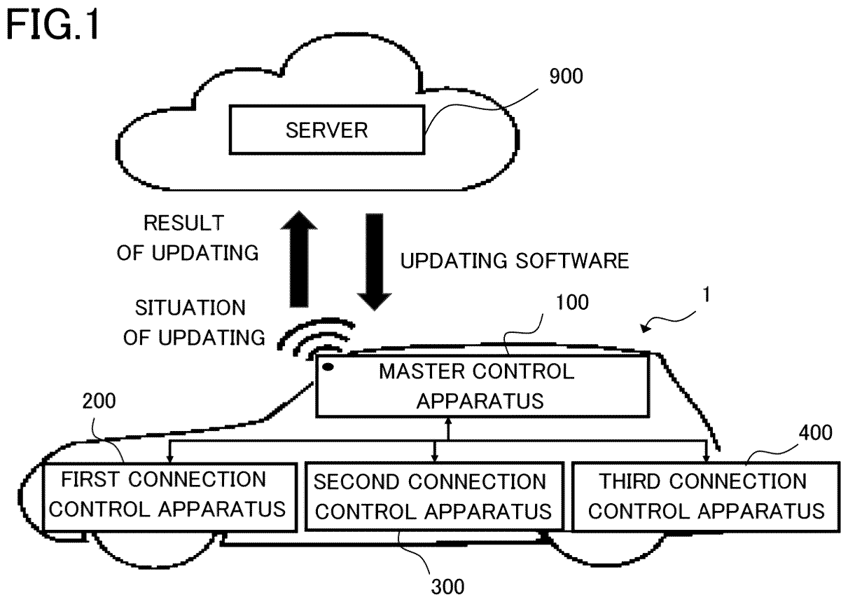

FIG. 1 is a schematic configuration diagram of a vehicle control apparatus 1 according to Embodiment 1. The vehicle control apparatus 1 includes a master control apparatus 100 and a first connection control apparatus 200, a second connection control apparatus 300, and a third connection control apparatus 400 that are connected with the master control apparatus 100. It may be allowed that there exists only one connection control apparatus to be connected with the master control apparatus 100. In addition, more connection control apparatuses may be set.

Each of the master control apparatus 100 and a server 900 can mutually communicate with each other via a wide area network. The server 900 can transmit updating software for raising a vehicle function to the vehicle control apparatus 1. FIG. 1 represents a case where the server 900 is included on a cloud; this configuration is represented by a drawing where the server 900 is on the cloud.

The master control apparatus 100 that receives updating software from the server 900 discriminates whether the updating software is for updating software incorporated in the master control apparatus 100 or any one of respective software items incorporated in the first connection control apparatus 200, the second connection control apparatus 300, and the third connection control apparatus 40. Then, the master control apparatus 100 transmits the updating software to the corresponding control apparatus so as to make that control apparatus rewrite its software.

### <Hardware Configuration of Control Apparatus>

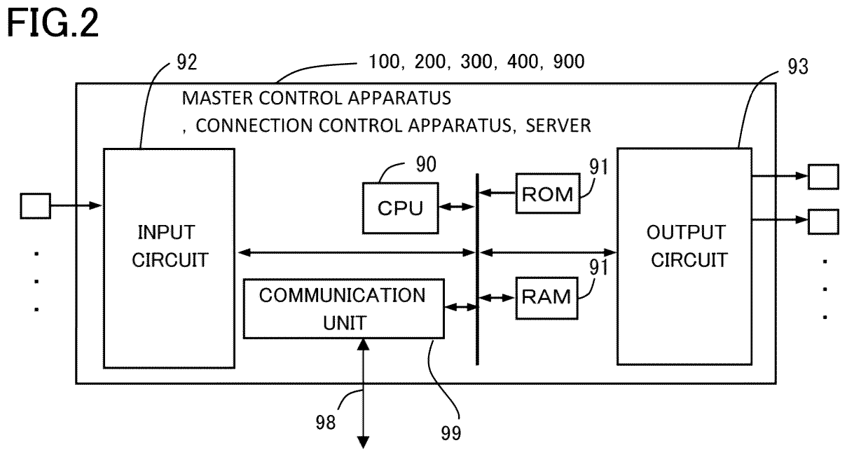

FIG. 2 is a hardware configuration diagram that can be applied to each of the master control apparatus 100, the first connection control apparatus 200, the second connection control apparatus 300, and the third connection control apparatus 400 in the vehicle control apparatus 1 according to Embodiment 1 and to the server 900. Hereinafter, as the representative, the master control apparatus 100 will be explained. Respective functions of the master control apparatus 100 are realized by processing circuits provided in the control apparatus 100. Specifically, as illustrated in FIG. 2, the master control apparatus 100 includes, as the processing circuits, a computing processing unit (computer) 90 such as a CPU (Central Processing Unit), storage apparatuses 91 that exchange data with the computing processing unit 90, an input circuit 92 that inputs external signals to the computing processing unit 90, an output circuit 93 that outputs signals from the computing processing unit 90 to the outside, and an interface such as a communication unit 99 that transmits or receives data via a communication path 98.

It may be allowed that as the computing processing unit 90, an ASIC (Application Specific Integrated Circuit), an IC (Integrated Circuit), a DSP (Digital Signal Processor), an FPGA (Field Programmable Gate Array), any one of various kinds of logic circuits, any one of various kinds of signal processing circuits, or the like is provided. It may be allowed that as the computing processing unit 90, an SoC (System on a Chip) technology is adopted. In addition, it may be allowed that as the computing processing unit 90, two or more computing processing units of the same type or different types are provided and respective processing items are executed in a sharing manner. As the storage apparatuses 91, there are provided a RAM (Random Access Memory) that can read data from and write data in the computing processing unit 90, a ROM (Read Only Memory) that can read data from the computing processing unit 90, and the like in the master control apparatus 100. The storage apparatus 91 may be incorporated in the computing processing unit 90. The input circuit 92 is connected with an input signal, sensors, and switches and is provided with an A/D converter and the like for inputting the input signal and signals from the sensors and the switches to the computing processing unit 90. The output circuit 93 is connected with electric loads such as a gate driving circuit for on/off-driving the switching devices and the like, and is provided with a driving circuit and the like for outputting control signals from the computing processing unit 90 to these electric loads. The communication unit 99 can exchange data with an external apparatus such as an external storage apparatus via the communication path 98.

The computing processing unit 90 runs software items (programs) stored in the storage apparatus 91 such as a ROM and collaborates with other hardware devices in the master control apparatus 100, such as the storage apparatus 91, the input circuit 92, and the output circuit 93, so that the respective functions provided in the master control apparatus 100 are realized. Setting data items such as a threshold value and a determination value to be utilized in the master control apparatus 100 are stored, as part of software items (programs), in the storage apparatus 91 such as a ROM. It may be allowed that the respective functions included in the master control apparatus 100 are configured with either software modules or combinations of software and hardware.

### <Connection of Respective Control Apparatuses>

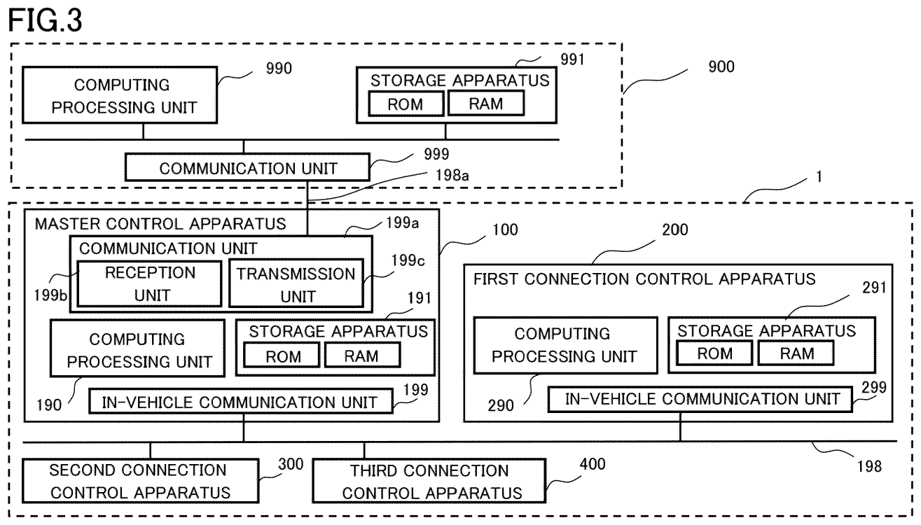

FIG. 3 is a diagram representing the connection in the vehicle control apparatus according to Embodiment 1. With regard to the schematic configuration diagram in FIG. 1, the respective hardware configurations of the control apparatuses that have been explained in FIG. 2 and the connection among the respective control apparatuses are represented. FIG. 3 shows an example in which the master control apparatus 100, the first connection control apparatus 200, the second connection control apparatus 300, and the third connection control apparatus 400 are connected with one another through a communication bus 198.

Software to be utilized for processing by the server 900 is written in a storage apparatus 991 of the server 900. In addition, the storage apparatus 991 also stores the latest software (referred to as updating software) for software that is utilized in the vehicle control apparatus 1 and is written in each of the respective storage apparatuses allocated to the computing processing units. A computing processing unit 990 of the server 900 transmits updating software from the communication unit 999, when it determines that the transmission is necessary. The server 900 transmits data to the vehicle control apparatus 1 through the wide area network 198a and instructs it to write the updating software.

Via a communication unit 199a, the master control apparatus 100 of the vehicle control apparatus 1 receives information on the updating software transmitted from the server 900. A computing processing unit 190 of the master control apparatus 100 determines whether the subject of the updating software is the master control apparatus 100 or any one of the other control apparatuses such as the first connection control apparatus 200 and the like. In the case where the subject of the updating software is not the software stored in a storage apparatus 191 of the master control apparatus 100, the computing processing unit 190 transfers data to the communication bus 198 via an in-vehicle communication unit 199.

There will be explained the case where in a storage apparatus 291, the first connection control apparatus 200 has software that is the subject of the updating software. Via an in-vehicle communication unit 299, the first connection control apparatus 200 receives the updating software transmitted from the server 900. A computing processing unit 290 of the first connection control apparatus 200 writes the updating software in the storage apparatuses 291. The first connection control apparatus 200 transmits writing-completion information from the in-vehicle communication unit 299. When receiving, from the in-vehicle communication unit 199 via the communication bus 198, the information indicating that the writing of the updating software has been completed, the master control apparatus 100 transmits this information to the server 900 from the communication unit 199a.

### <Function Block of Master Control Apparatus>

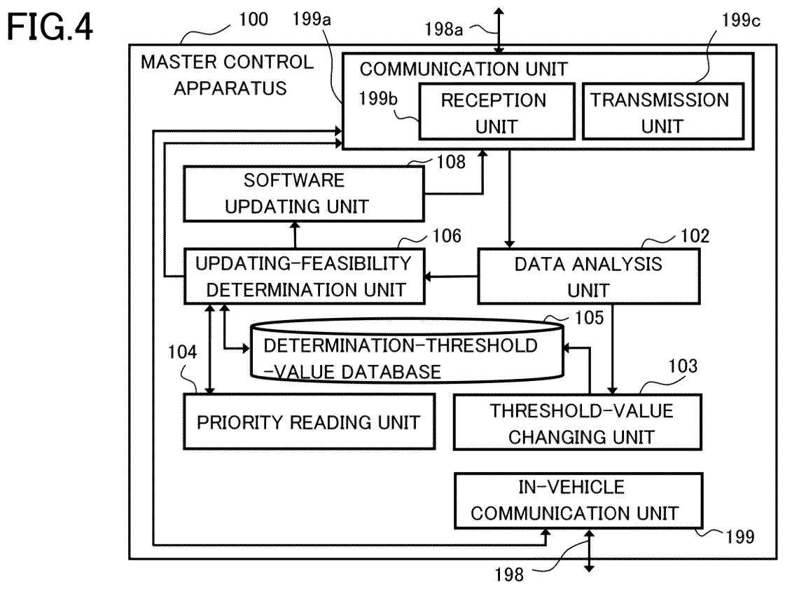

FIG. 4 is a functional block diagram of the master control apparatus 100 in the vehicle control apparatus 1 according to Embodiment 1. The function of each of the blocks will be explained.

Via the wide area network 198a, the communication unit 199a communicates with the server 900 outside the vehicle, by use of the OTA technology. The communication unit 199a has a reception unit 199b and a transmission unit 199c. Through the reception unit 199b, the master control apparatus 100 receives an updating program from the server 900. The master control apparatus 100 transmits the result of software updating and the result of updating-feasibility determination to the server 900, through the transmission unit 199c.

The communication unit 199a determines whether the data received from the server 900 is to be delt with by the master ECU 100 or by any one of the other connection control apparatuses. In the case where the data received from the server 900 is to be delt with by any one of the other connection control apparatuses, the communication unit 199a transmits the received data to the corresponding connection control apparatus from the in-vehicle communication unit 199 via the communication bus 198 inside the vehicle. In the case where the data received from the server 900 is to be delt with by the master ECU 100, the communication unit 199a transmits the received data to a data analysis unit 102.

The data analysis unit 102 determines whether the transmitted data is information for updating priority-threshold-value data or updating software (hereinafter, the priority threshold value will be referred to as a “threshold value”). In the case of information for updating the threshold-value data, the data analysis unit 102 transmits the data to a threshold-value changing unit 103 so as to update a determination-threshold-value database 105.

In the case where the transmitted data is updating software, the data analysis unit 102 discriminates updating-subject software (or the apparatus including the updating-subject software) and then transmits the data to an updating-feasibility determination unit 106.

The updating-feasibility determination unit 106 reads the priority of the updating-subject software from a priority reading unit 104. The updating-feasibility determination unit 106 reads the threshold value from the determination-threshold-value database 105. In the case where the priority of the updating-subject software is larger than the threshold value, the updating-feasibility determination unit 106 makes a software updating unit 108 write the updating software. For example, when the priority of the software has 10 levels, the updating-feasibility determination unit 106 makes a determination such as that in the case where the priority of the updating-subject software is the same as or larger than 6 in the threshold value, the updating is executed. After the updating software has been updated, the software updating unit 108 transmits data to the communication unit 199a so as to send the fact of completion of the updating to the server 900.

In the case where the priority of the updating-subject software is the same as or smaller than the threshold value, the updating-feasibility determination unit 106 withholds the software from being updated. The updating-feasibility determination unit 106 transmits data to the communication unit 199a so as to send the fact to the server 900.

### <Function Block of Connection Control Apparatus>

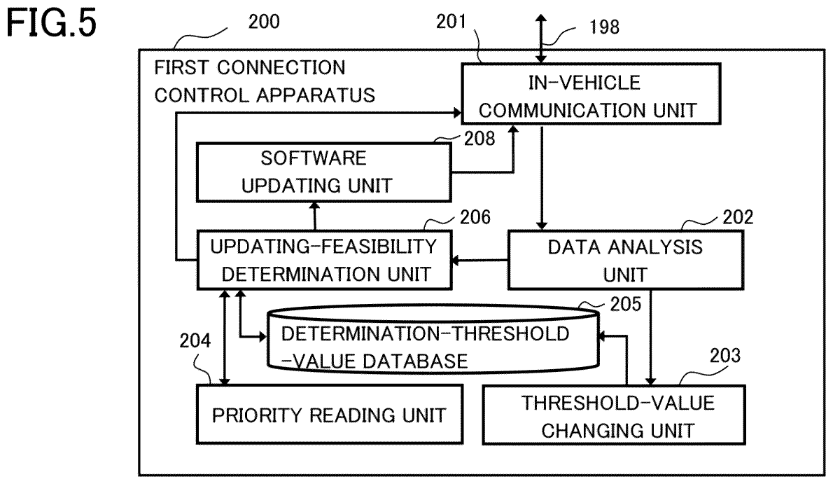

FIG. 5 is a functional block diagram of the first connection control apparatus 200 in the vehicle control apparatus 1 according to Embodiment 1. In the present embodiment, the first connection control apparatus 200 will be explained; however, even when the data received from the server 900 is to be dealt with by another connection control apparatus, said another connection control apparatus can also deal with the data. Because the function of each of the other connection control apparatuses is the same as that of the first connection control apparatus 200, there will be explained the first connection control apparatus 200, as a representative.

Via the communication bus 198 inside the vehicle, an in-vehicle communication unit 201 receives data transferred from the master control apparatus 100. The in-vehicle communication unit 201 determines whether the received data is to be delt with by the first connection control apparatus 200 or by any one of the other connection control apparatuses. In the case where the received data is to be delt with by the first connection control apparatus 200, the in-vehicle communication unit 201 transmits the received data to a data analysis unit 202.

The data analysis unit 202 determines whether the transmitted data is information for updating threshold-value data or updating software. In the case of information for updating the threshold-value data, the data analysis unit 202 transmits the data to a threshold-value changing unit 203 so as to update a determination-threshold-value database 205.

In the case where the transmitted data is updating software, the data analysis unit 202 discriminates updating-subject software (or the apparatus including the updating-subject software) and then transmits the data to an updating-feasibility determination unit 206.

The updating-feasibility determination unit 206 reads the priority of the updating-subject software from a priority reading unit 204. The updating-feasibility determination unit 206 reads the threshold value from the determination-threshold-value database 205. In the case where the priority of the updating-subject software is larger than the threshold value, the updating-feasibility determination unit 206 makes a software updating unit 208 write the updating software. For example, when the priority of the software has 10 levels, the updating-feasibility determination unit 206 makes a determination such as that in the case where the priority of the updating-subject software is the same as or larger than 6 in the threshold value, the updating is executed. After the updating software has been updated, the software updating unit 208 transmits data to the in-vehicle communication unit 201 so as to send the fact of completion of the updating to the server 900. The communication unit 199a of the master control apparatus 100 transmits the transmitted data to the server 900.

In the case where the priority of the updating-subject software is the same as or smaller than the threshold value, the updating-feasibility determination unit 206 withholds the software from being updated. The updating-feasibility determination unit 206 transmits data to the in-vehicle communication unit 201 so as to send the fact to the server 900. The communication unit 199a of the master control apparatus 100 transmits the transmitted data to the server 900.

### <Referring to Data to be Operated by Updating Software>

In the foregoing description, it has been explained that only when the priority of software to be updated is larger than the threshold value, the software is updated. Setting the priority levels makes it possible to avoid the probability that when software is updated, updating of software with a high priority is postponed and hence an adverse effect is provided to the behavior of the vehicle control apparatus.

In this situation, data to be operated by software to be updated will be considered. In some cases, software shares OSs, programs, or data with other software items. The shared data includes setting information, contents (e.g., sound, images, and pictures), and the like. When the software to be updated operates these OSs, programs, or data so as to rewrite the data, effects are provided to the other software items that share the foregoing items.

The foregoing situation can be paraphrased by a case where there exists second software (referred to also as reference software) that refers to data to be operated by first software to be updated. In this case, there exists a probability that updating the first software provides an effect to the behavior of the second software. In this situation, when the priority of the second software is larger than the threshold value, it may be allowed that in light of the effect, the updating of the software is withheld. The foregoing method makes it possible to continue the traveling of the vehicle without updating the conventional software. Accordingly, adverse effects caused by unexpected operation of the second software can be prevented.

Thus, in the case where there exists second software that refers to the data to be operated by first software to be updated, it is only necessary that only when the priority of the second software is the same as or smaller than the threshold value, the updating software is rewritten. This is because low-priority software provides a small effect to the behavior of the vehicle and hence the probability that a problem is caused by updating the first software is low. Updating of first software can be applied to both the case where only the first software is updated and the case where the first software and data (including shared Oss and programs) are updated.

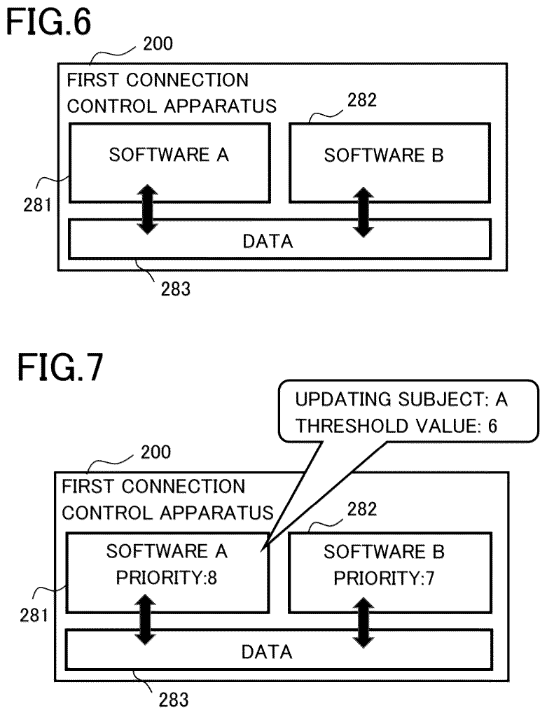

FIG. 6 is an example of a first software configuration diagram of the first connection control apparatus 200 in the vehicle control apparatus 1 according to Embodiment 1. In the present embodiment, software (A) 281 and software (B) 282 written in the storage apparatus of the first connection control apparatus 200 will be described. The software (A) 281 and the software (B) 282 share data 283. Updating of the software (A) 281 while the software (A) 281 operates the data 283 may cause a problem, because a discontinuous value is written in the data 283.

FIG. 7 is a second software configuration diagram of the first connection control apparatus 200 in the vehicle control apparatus 1 according to Embodiment 1. In this situation, the software (A) 281 has the priority “8” and the software (B) 282 has the priority “2”. In this case, there will be considered the case where as the software-updating subject, the software (A) 281 is selected.

In the case where the threshold value “6” is set, the priority “8” of the software (A) 281, as the first software, is larger than the threshold value “6”. In addition, the priority of the software (B) 282, as the second software that refers to the data 283 to be operated by the software (A) 281, as the first software, is the same as or smaller than the threshold value “6”. Thus, it is determined that the software (A) 281 represented in FIG. 7 can be updated.

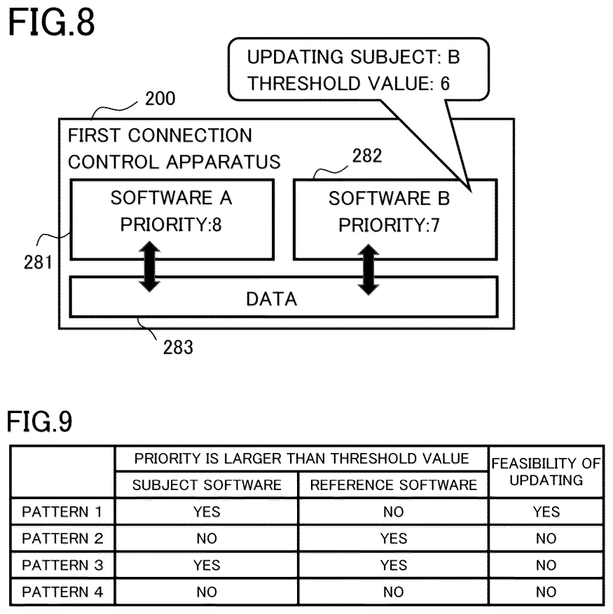

FIG. 8 is a third software configuration diagram of the first connection control apparatus 200 in the vehicle control apparatus 1 according to Embodiment 1. In this situation, the software (A) 281 has the priority “8” and the software (B) 7 has the priority “7”. In this case, there will be considered the case where as the software-updating subject, the software (B) is selected.

In the case where the threshold value “6” is set, the priority “7” of the software (B) 282, as the first software, is larger than the threshold value “6”. In addition, the priority of the software (A) 281, as the second software that refers to the data 283 to be operated by the software (B) 282, as the first software, is not the same as or smaller than the threshold value “6”. Thus, it is determined that the software (B) 282 represented in FIG. 8 is withheld from being updated.

In FIGS. 6 through 8, there has been explained the respective cases where the software (A) 281 and the software (B) 282 that share the data 283 for the first connection control apparatus 200 are updated. However, this explanation is not limited to the first connection control apparatus 200. These examples can be applied to updating of the software items for the master control apparatus 100 and other connection control apparatuses.

### <Combination of Updating Software and Reference Software>

FIG. 9 is a table for explaining the combination of updating-feasibility determinations at the time of software updating according to Embodiment 1. When two software items, i.e., updating-subject software and reference software exist, the case where the priority of each of the foregoing software items is larger than the threshold value is indicated by “YES” and the case where the priority of each of the foregoing software items is the same as or smaller than the threshold value is indicated by “NO”. There can be conceived four combinations, i.e., Pattern 1, Pattern 2, Pattern 3, and Pattern 4 in each of which each of the foregoing cases is “YES” or “NO”. Only in Pattern 1 among these patterns, it is determined that the updating-subject software can be updated (YES).

In each of Patterns 2, 3, and 4, updating of the updating-subject software is withheld (NO). Accordingly, a case is conceivable in which software is not updated but continues to be executed. In the case where there exist two or more software items that share data and have high priorities, these software items are simultaneously updated, so that the latest-version software items can be utilized while contingencies are avoided.

In addition, it may be allowed that the case where there exist two or more software items that share data and have high priorities is dealt with by a forcible instruction of updating from the server 900, by changing the priority of dynamic software, or by updating the threshold value. In some cases, these measures are required in order to apply a security patch to the software or to fix bugs.

### <Flowchart of Processing by Master Control Apparatus>

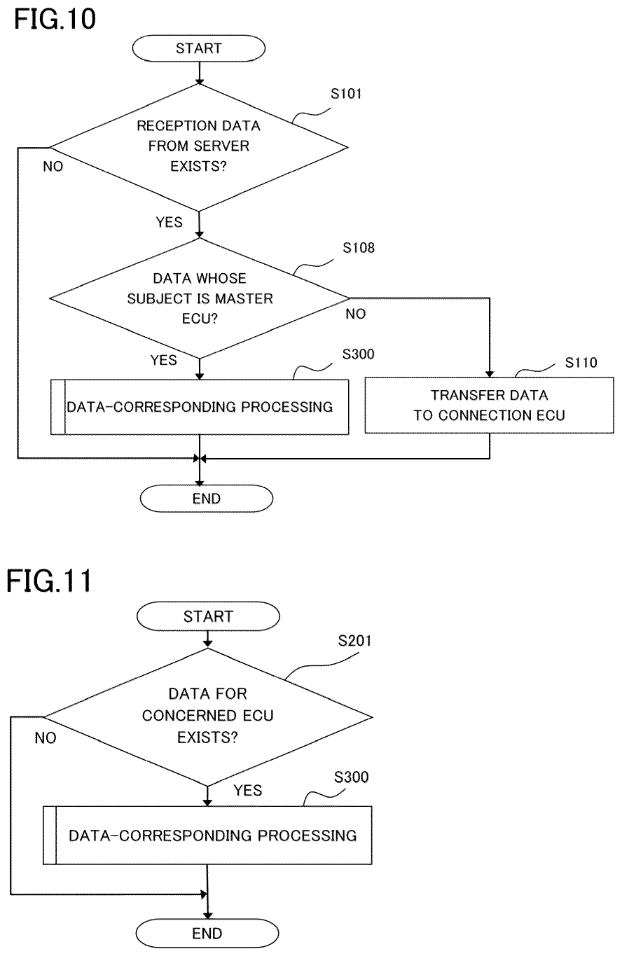

FIG. 10 is a flowchart representing processing by the master control apparatus 100 of the vehicle control apparatus 1 according to Embodiment 1. The flowchart in FIG. 10 explains the flow in which the respective function blocks of the master control apparatus 100, explained in FIG. 4, operate.

The processing in the flowchart in FIG. 10 is performed every predetermined time (for example, every 10 ms). The processing represented in FIG. 10 may be performed not every predetermined time but every event, for example, each time the vehicle has traveled a predetermined distance or each time the master control apparatus 100 receives data from the server 900, or the like.

After the processing is started, it is determined in the step S101 whether or not there exists reception data received from the server. In the case where there exists no reception data (the determination result is NO), the processing is ended. In the case where there exists reception data (the determination result is YES), the step S101 is followed by the step S108.

In the step S108, it is determined whether or not the reception data is data whose subject is the master control apparatus 100. Hereinafter, in the flowchart, the control apparatus is described as ECU (Electronic Control Unit). In the case where the reception data is not data whose subject is the master control apparatus 100 (the determination result is NO), the step S108 is followed by the step S110.

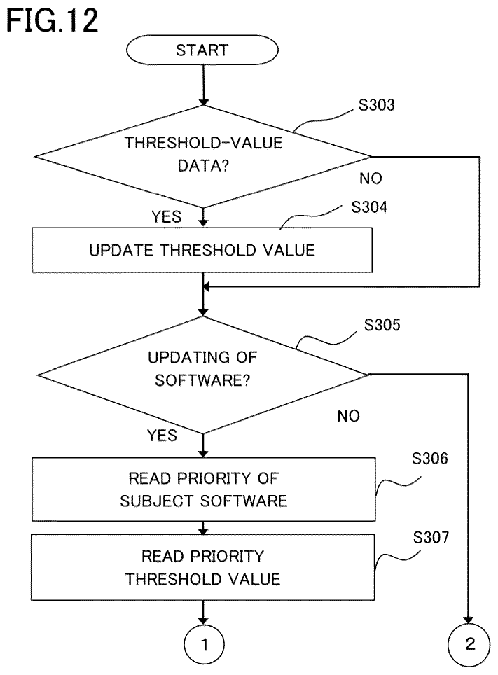

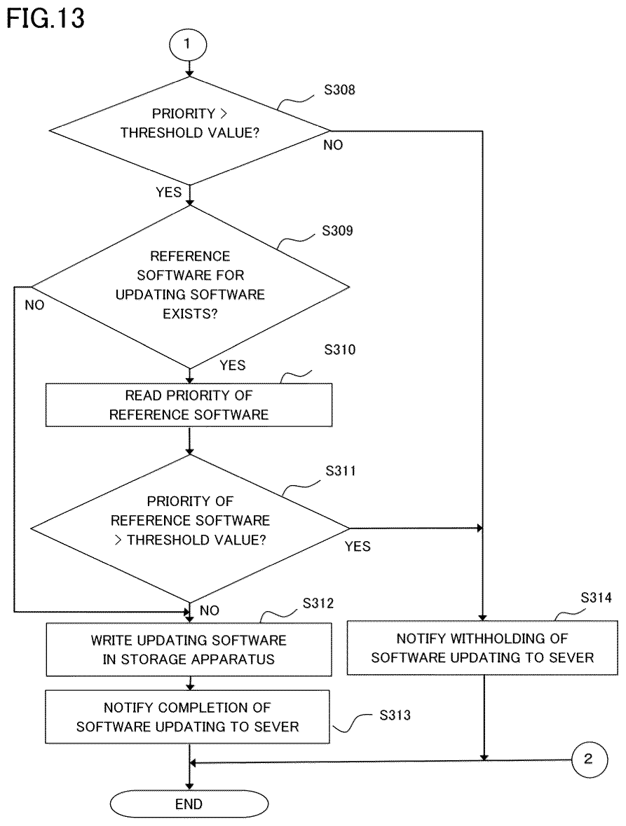

In the case where in the step S108, the reception data is data whose subject is the master control apparatus 100 (the determination result is YES), data-corresponding processing in the step S300 is performed. In the step S300, threshold-value data is updated or it is determined whether or not software can be updated; in the case where it is determined that software can be updated, the software is updated. Then, the foregoing processing is ended. The contents of the step S300 will be explained in detail in FIGS. 12 and 13.

In the step S110, the in-vehicle communication unit 199 transfers the reception data to the subject connection ECU. Then, the foregoing processing is ended.

### <Flowchart of Processing by Connection Control Apparatus>

FIG. 11 is a flowchart representing processing by the connection control apparatus in the vehicle control apparatus according to Embodiment 1. The flowchart in FIG. 11 explains the flow in which the respective function blocks of the connection control apparatus, represented by the first connection control apparatus 200 explained in FIG. 5, operate.

The processing in the flowchart in FIG. 11 is performed every predetermined time (for example, every 10 ms). The processing represented in FIG. 11 may be performed not every predetermined time but every event, for example, each time the vehicle has traveled a predetermined distance or each time the connection control apparatus receives data from the master control apparatus 100, or the like.

After the processing is started, it is determined in the step S201 whether or not there exists data, destined to the foregoing ECU, that has been transmitted from the master control apparatus 100 and received via the communication bus 198. In the case where there exists no reception data (the determination result is NO), the processing is ended. In the case where there exists reception data (the determination result is YES), the step S201 is followed by the step S300. In the step S300, data-corresponding processing is performed. In the step S300, the threshold-value data is updated or it is determined whether or not software can be updated; in the case where it is determined that software can be updated, the software is updated. Then, the foregoing processing is ended. The contents of the step S300 will be explained in detail in FIGS. 12 and 13.

### <Flowchart of Data-Corresponding Processing>

FIG. 12 is a first flowchart representing data-corresponding processing by the vehicle control apparatus 1 according to Embodiment 1. FIG. 13 is a second flowchart representing the data-corresponding processing by the vehicle control apparatus 1 according to Embodiment 1; FIG. 13 represents the processing after that in FIG. 12. The data-corresponding processing represented in FIGS. 12 and 13 shows the details of the data-corresponding processing represented in the step S300 in each of FIGS. 10 and 11. The data-corresponding processing is the processing to be executed by the master control apparatus 100 or by the connection control apparatuses represented by the first connection control apparatus 200.

After the data-corresponding processing is started, it is determined in the step S303 whether or not the reception data is threshold-value data. In the case where the reception data is not threshold-value data (the determination result is NO), the step S303 is followed by the step S305.

In the case where in the step S303, the reception data is threshold-value data (the determination is “YES”), the threshold value is updated in the step S304. Specifically, the data analysis unit transmits the threshold value to be updated to the threshold-value changing unit; then, the threshold-value changing unit updates the threshold value database. After that, the step S304 is followed by the step S305.

In the step S305, it is determined whether or not the reception data is software-updating data. In the case where the reception data is not software-updating data (the determination result is NO), the processing is ended.

In the case where in the step S305, the reception data is software-updating data (the determination is “YES”), the step S305 is followed by the step S306. In the step S306, the priority of the subject software is read from the priority reading unit; then, the step S306 is followed by the step S307.

In the step S307, the threshold value is read from the determination-threshold-value database. After that, the step S307 is followed by the step S308.

In the step S308 in FIG. 13, it is determined whether or not the priority of the read subject software is larger than the threshold value. In the case where the priority of the read subject software is not larger than the threshold value (the determination result is NO), the step S308 is followed by the step S314.

In the case where in the step S308, the priority of the read subject software is larger than the threshold value (the determination result is YES), the step S308 is followed by the step S309. In the step S309, it is determined whether or not there exists reference software in the updating software. That is to say, it is determined whether or not another software refers to data to be operated by the software to be updated. In the case where no reference software exists in the updating software (the determination result is NO), the step S309 is followed by the step S312.

In the case where in the step S309, reference software exists in the updating software (the determination is “YES”), the step S309 is followed by the step S310. In the step S310, the priority of the reference software is read through the priority-level reading unit.

Next, in the step S311, it is determined whether or not the priority of the reference software is larger than the threshold value. In the case where the priority of the reference software is larger than the threshold value, i.e., the priority value is not the same as or smaller than the threshold value (the determination result is YES), the step S311 is followed by the step S314.

In the step S314, it is notified to the server 900 that the updating of the software is withheld. After that, the foregoing processing is ended.

In the case where in the step S311, the priority of the reference software is not larger than the threshold value, i.e., the priority value is the same as or smaller than the threshold value (the determination result is NO), the step S311 is followed by the step S312. In the step S312, the updating software is written in the storage apparatus. Then, in the step S313, it is notified to the server 900 that the updating of the software has been completed. After that, the foregoing processing is ended.

As described above, only when the priority of the updating software is the same as or larger than the threshold value, updating of the software is performed; thus, it is made possible to preferentially update the software that requires to be updated. Moreover, in the case where there exists software that refers to the data to be operated by software to be updated, updating of the software is performed only when the priority of the reference software is the same as or smaller than the threshold value. As a result, the latest-version software items can be utilized while adverse effects caused by unexpected operation of software that refers to shared data are avoided.

Moreover, when the server 900 issues instruction of changing the threshold value, the threshold value can be updated. As a result, it is made possible to continue updating of the software for the vehicle control apparatus 1, while changing the threshold value to the optimum one.

### <Reference Software, Importance Data>

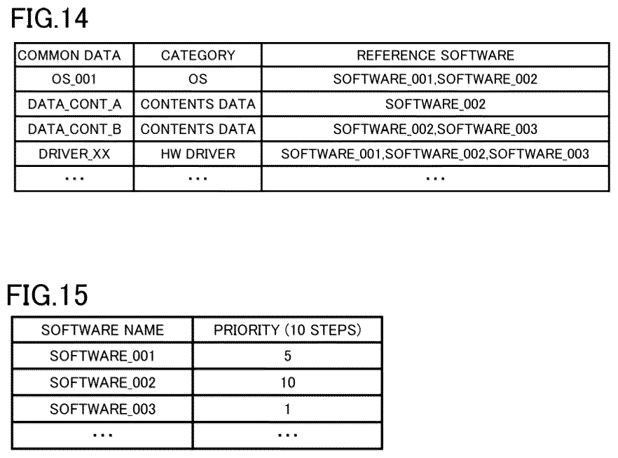

FIG. 14 is a table for explaining the relationship between common data and reference software at the time of software updating according to Embodiment 1. FIG. 14 represents an example of a list of software items that refer to respective common data items. In the case where each of the software items that operate these common data items is updated, it is required to ascertain the priority of each of the software items that refer to these common data items and to determine that the foregoing priority is the same as or smaller than the threshold value.

FIG. 15 is a table for explaining priority management at the time of software updating according to Embodiment 1. FIG. 15 indicates that priorities are specified for the respective software items in the control apparatus.

The data items represented in FIGS. 14 and 15 are stored in the storage apparatus of the control apparatus. Then, these data items are utilized so as to perform reading of the priority of each of the software items, reading of the priority of the reference software, and comparison with the threshold value at the time of software updating.

### 2. Embodiment 2

### <Function Block of Master Control Apparatus>

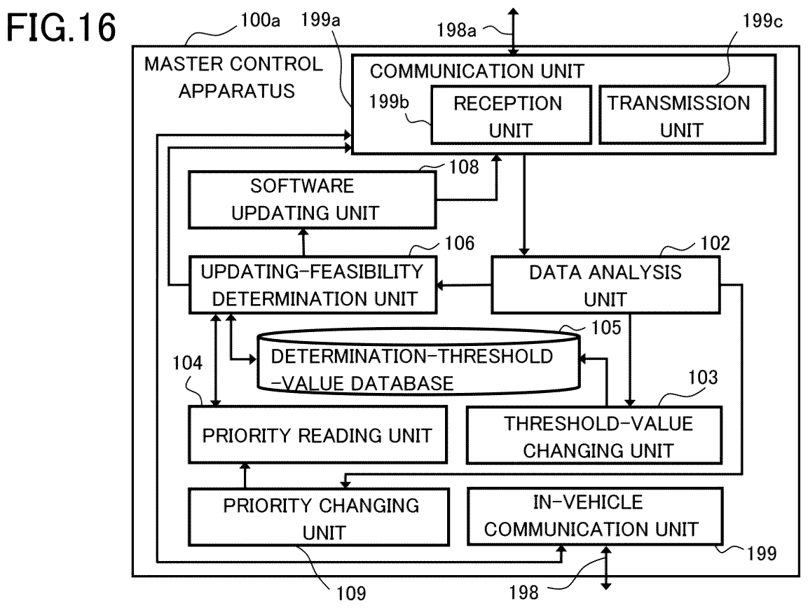

FIG. 16 is a functional block diagram of a master control apparatus 100a in a vehicle control apparatus 1a according to Embodiment 2 (the vehicle control apparatus 1a is unillustrated). The master control apparatus 100a represented in FIG. 16 according to Embodiment 2 is different from the master control apparatus 100 represented in FIG. 4 according to Embodiment 1 in that a priority changing unit 109 is added therein. The hardware configuration of the control apparatus represented in FIG. 2 can be applied also to the master control apparatus 100a.

The master control apparatus 100a according to Embodiment 2 can change the priority by use of reception data from the server 900. In the case where reception data from the server 900 is data whose subject is the master control apparatus 100a, the communication unit 199a transmits the reception data to the data analysis unit 102; in the case where reception data is data that updates the priority, the data analysis unit 102 transfers the priority data to the priority changing unit 109 so as to make the priority changing unit 109 update the priority of the priority reading unit 104.

### <Function Block of Connection Control Apparatus>

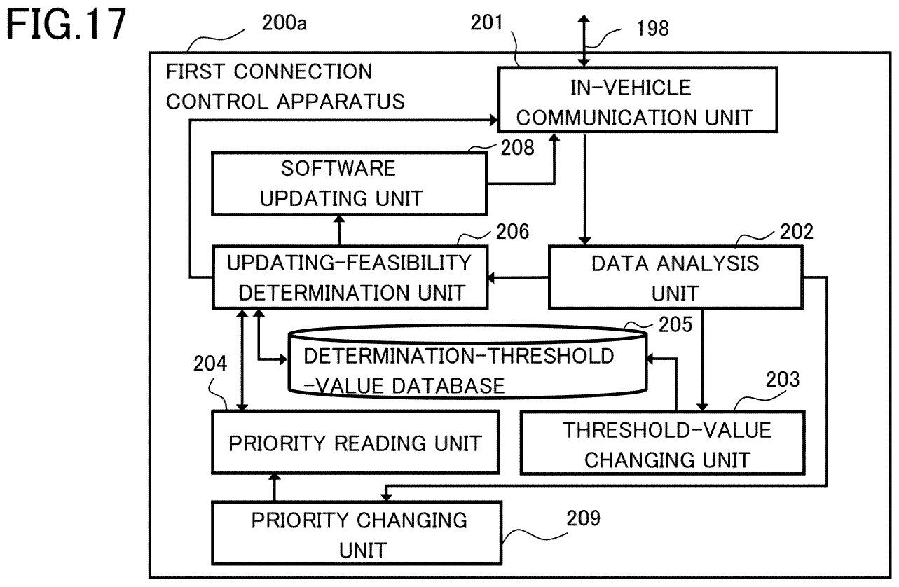

FIG. 17 is a functional block diagram of a first connection control apparatus 200a in the vehicle control apparatus 1a according to Embodiment 2. The first connection control apparatus 200a represented in FIG. 17 according to Embodiment 2 is different from the first connection control apparatus 200 represented in FIG. 5 according to Embodiment 1 in that a priority changing unit 209 is added therein. The hardware configuration of the control apparatus represented in FIG. 2 can be applied also to the first connection control apparatus 200a.

The first connection control apparatus 200a according to Embodiment 2 can change the priority by use of reception data from the server 900. In the case where reception data from the server 900 is data whose subject is the first connection control apparatus 200a, the in-vehicle communication unit 201 to which the reception data is transferred from the master control apparatus 100a transmits the reception data to the data analysis unit 202; in the case where reception data is data that updates the priority, the data analysis unit 202 transfers the priority data to the priority changing unit 209 so as to make the priority changing unit 209 update the priority of the priority reading unit 204.

### <Flowchart of Data-Corresponding Processing>

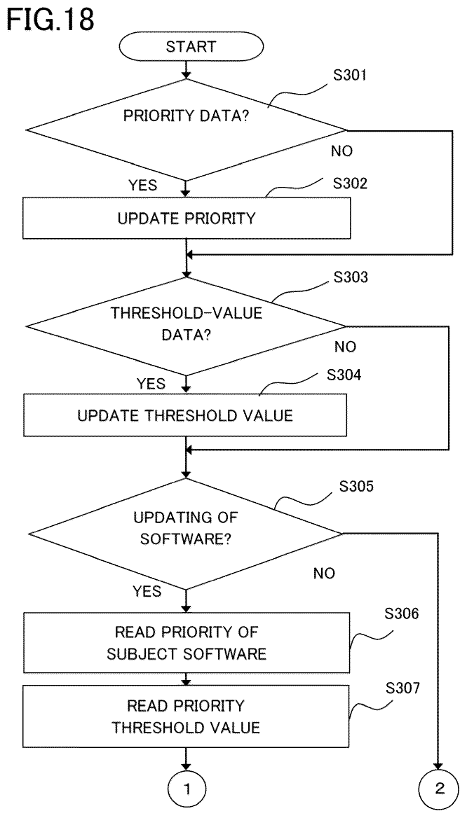

FIG. 18 is a first flowchart representing data-corresponding processing by the vehicle control apparatus 1a according to Embodiment 2. FIGS. 10, 11, and 13, which configure the flowchart of the processing according to Embodiment 1 can be applied to the flowchart of the processing by the vehicle control apparatus 1a according to Embodiment 2. The flowchart in FIG. 18 according to Embodiment 2 is different from that in FIG. 12 according to Embodiment 1 in that some steps are added therein. FIG. 18 represents the first half of data-corresponding processing according to Embodiment 2. FIG. 13 can be applied to the second half of the data-corresponding processing.

The first flowchart in FIG. 18 representing the data-corresponding processing is different from that in FIG. 12 only in that the steps S301 and S302 are added before the step S303 in FIG. 12. Different parts will be explained, but the explanations for the same parts will be omitted.

In the flowchart in FIG. 18, after the data-corresponding processing is started, it is determined in the step S301 whether or not the reception data is priority data. In the case where the reception data is not priority data (the determination result is NO), the step S301 is followed by the step S303.

In the case where in the step S301, the reception data is priority data (the determination is “YES”), the priority data is updated in the step S302. Specifically, the data analysis unit transmits the priority data to be updated to the priority changing unit; then, the priority changing unit 109 updates the priority data in the priority reading unit. After that, the step S302 is followed by the step S303.

As described above, in Embodiment 2, the priority data can be updated by an instruction from the server 900; thus, it is made possible to perform appropriate software updating by changing, as may be necessary, the software to be updated. Changing the priority of the reference software makes it possible to perform appropriate software updating.

### 3. Embodiment 3

### <Function Block of Master Control Apparatus>

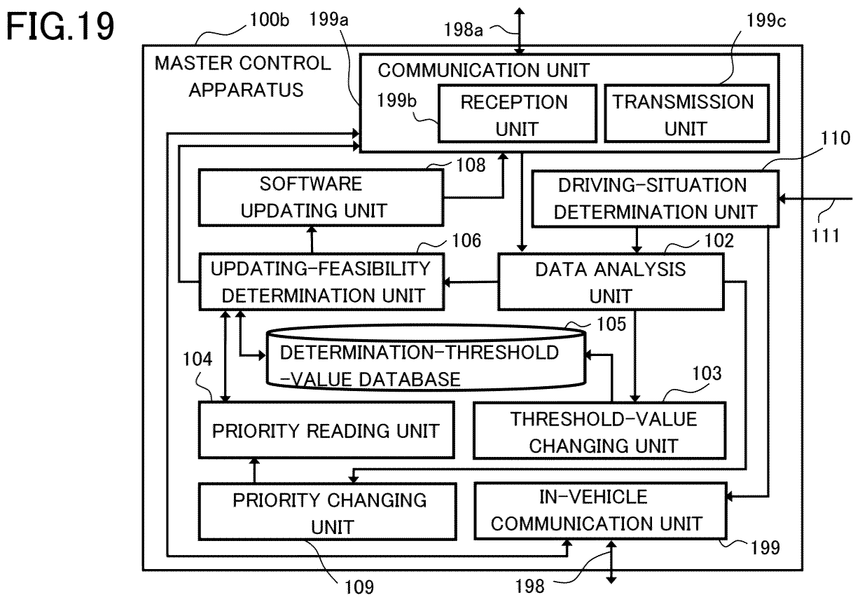

FIG. 19 is a functional block diagram of a master control apparatus 100b in a vehicle control apparatus 1b according to Embodiment 3 (the vehicle control apparatus 1b is unillustrated). The master control apparatus 100b represented in FIG. 19 according to Embodiment 3 is different from the master control apparatus 100a represented in FIG. 16 according to Embodiment 2 in that a driving-situation determination unit 110 is added therein. The hardware configuration of the control apparatus represented in FIG. 2 can be applied also to the master control apparatus 100b.

The master control apparatus 100b according to Embodiment 3 can change the priority by determining the driving situation of the vehicle. By receiving a driving-situation signal from a driving-situation signal line 111, the driving-situation determination unit 110 determines the driving situation of the vehicle. The driving situations can include the place where the vehicle is located, the time in which the vehicle exists, the date (day/month/year), the weather, the on/off state of the ignition switch, the vehicle speed, the engine rotation speed, the remaining capacity of the battery, the hardware configuration of the vehicle control apparatus, the situation of the software configuration, and the like. It is made possible to change the respective priorities of the software items in accordance with these situations.

In the case where the surroundings is dark, for example, in the night time zone, updating of the software related to control of the lighting is important. In such cases, it may be allowed that the updating priority of the software related to control of lighting is raised. Based on the information related to the place (area) where the vehicle exists and the date (month/day), the respective updating priorities of the sideslip prevention device and the antilock braking control apparatus may be raised in the winter season of the area having much snow. It may be allowed that the data-updating priority of the software including data for the navigation apparatus is raised in the area near to the point at which the vehicle exists.

In addition, it is made possible that only in the period where the vehicle is in a stop state or the ignition switch is off, the priority of specific software is raised so as to prompt updating of the software in that state. It may be allowed that only in the state where the remaining capacity of the battery is large, the priority of specific software is raised so as to prompt updating.

In some cases, in the hardware configuration and the software configuration of a control apparatus, the storage apparatus is duplicated at the time of software updating. In such a situation, even when a problem occurs during software updating, the state where the previous-version software has been executed can be restored at any time. Accordingly, it may be allowed that the respective priorities of software items are changed by utilizing, as the indexes, the margin degrees of the hardware configuration and the software configuration. It may be allowed that because in the situation where the storage apparatus is duplicated at the time of software updating, the margin degree of the configuration is high, the priority of the corresponding software is raised. This method makes it possible to increase the opportunity for updating the corresponding software.

### <Flowchart of Processing by Master Control Apparatus>

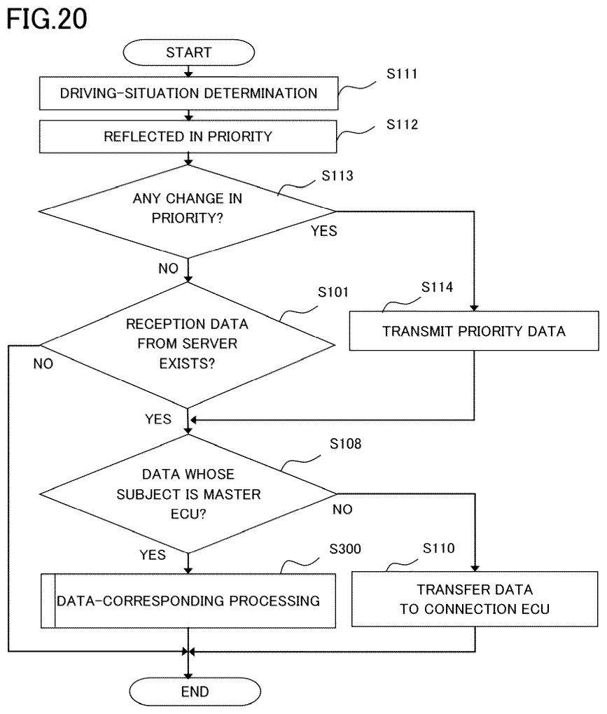

FIG. 20 is a flowchart representing processing by the master control apparatus 100b of the vehicle control apparatus 1b according to Embodiment 3. FIGS. 11, 13, and 18, which configure the flowchart of the processing to be applied to Embodiment 2 can be applied to the flowchart of the processing by the vehicle control apparatus 1b according to Embodiment 3. The flowchart of the processing in FIG. 20 according to Embodiment 3 is different from the flowchart in FIG. 10 applied to Embodiment 2 in that some steps are added to the flowchart in FIG. 10.

FIG. 20, which is the flowchart of the processing by the master control apparatus 100b according to Embodiment 3, is different from FIG. 10, which is the flowchart of the processing by the master control apparatus common to Embodiment 1 and Embodiment 2, in that the steps S111 through S114 are added before the step S101. Different parts will be explained, but the explanations for the same parts will be omitted.

In the flowchart in FIG. 20, in the step S111 after the processing by the master control apparatus 100b is started, the driving-situation determination unit 110 receives the driving-situation signal from the driving-situation signal line 111 and then determines the driving situation of the vehicle. Next, in the step S112, the driving situation is reflected in the priority.

In the step S113, it is determined whether or not as a result of the reflection of the driving situation in the priority, any change has occurred in the priority data. In the case where no change has occurred (the determination result is NO), the step S113 is followed by the step S101, where the conventional processing is performed.

In the case where in the step S113, any change has occurred (the determination result is YES), the step S113 is followed by the step S114, where the priority data is processed by the master ECU or the connection ECU. In the case where the updated priority data is data whose subject is the master ECU, the priority data is sent to the priority changing unit so that the priority data of the master ECU is updated. When the updated priority data is not data whose subject is the master ECU, the priority data is sent to the priority changing unit of the corresponding connection ECU. Then, the priority data of the corresponding connection ECU is updated.

As described above, in Embodiment 3, the driving situation detected by the driving-situation determination unit is reflected in the priority as to update the priority data.

Accordingly, it is made possible to perform appropriate software updating by dynamically changing the respective priorities of the software items.

### 4. Embodiment 4

### <Function Block of Master Control Apparatus>

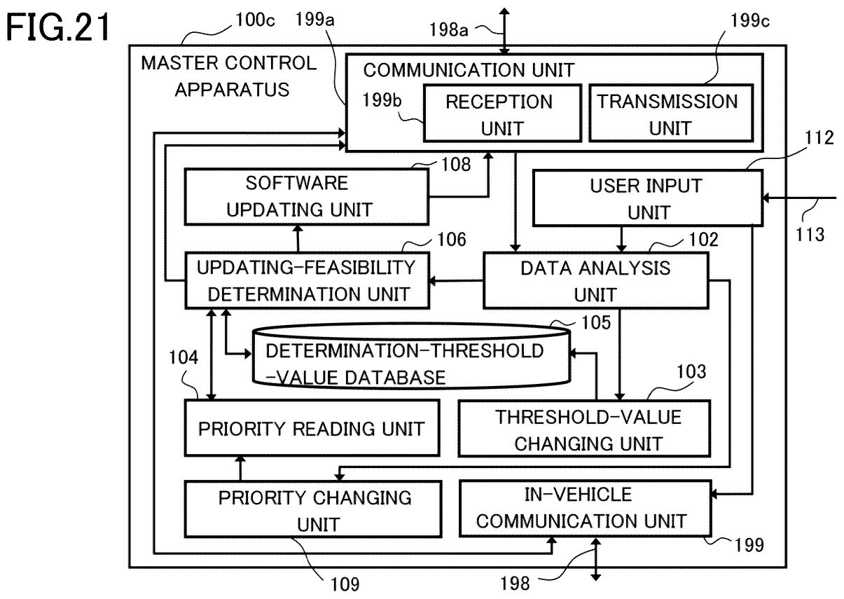

FIG. 21 is a functional block diagram of a master control apparatus 100c in a vehicle control apparatus 1c according to Embodiment 4 (the vehicle control apparatus 1c is unillustrated). The master control apparatus 100c represented in FIG. 21 according to Embodiment 4 is different from the master control apparatus 100b represented in FIG. 19 according to Embodiment 3 in that the driving-situation determination unit 110 is replaced by a user input unit 112. The hardware configuration of the control apparatus represented in FIG. 2 can be applied also to the master control apparatus 100c.

The master control apparatus 100c according to Embodiment 4 can change the respective priorities of the software items by user's (driver's) inputting. The user input unit 112 receives a user's input signal from a user interface signal line 113 and then updates the priority of the software.

In some cases, the required application and function differ depending on the driving ability, the request, the hobby, and the taste of a user. It may be allowed to change the priority of the software, based on the will of a user, such as “always keeping the automatic driving application as the latest version” and “because the entertainment application is hardly utilized, the necessity of updating thereof is low”.

Based on an input signal from an apparatus having an HMI (Human-Machine-Interface) such as a navigation apparatus, a signal is inputted to the user input unit 112. It may be allowed that the user's instruction of changing the priority is issued for each of the software items. However, it may be allowed that software services provided by the vehicle control apparatus are categorized so that the priority is instructed for each of the categories.

The user input unit 112 makes it possible to change the priority of the software by the user's (driver's) instruction. Accordingly, high-customer-satisfaction updating of the software can be performed. Because a user directly changes the priority of the software, software updating that is optimum to the user can be performed.

### <Flowchart of Processing by Master Control Apparatus>

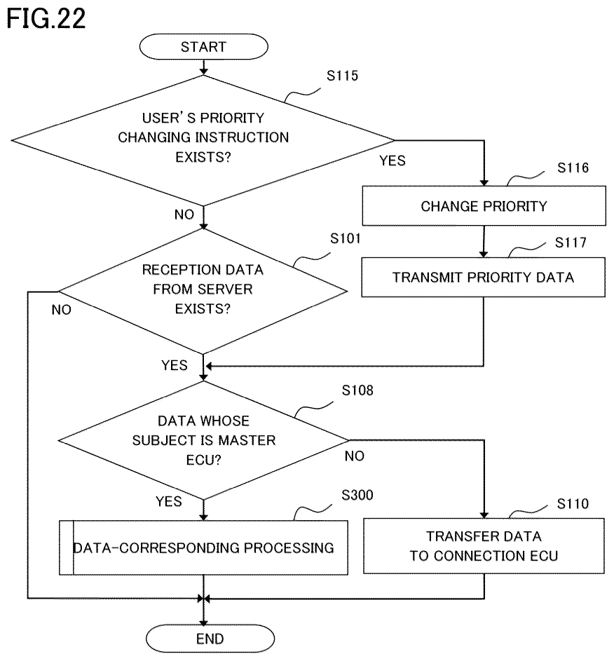

FIG. 22 is a flowchart representing processing by the master control apparatus 100c of the vehicle control apparatus 1c according to Embodiment 4. FIGS. 11, 13, and 18, which configure the flowchart of the processing to be applied to Embodiment 3 can be applied to the flowchart of the processing by the vehicle control apparatus 1c according to Embodiment 4. The flowchart of the processing in FIG. 22 according to Embodiment 4 is different from the flowchart in FIG. 20 applied to Embodiment 3 in that some steps therein replace some steps in the flowchart in FIG. 20.

FIG. 22, which is the flowchart of the processing by the master control apparatus 100b according to Embodiment 4, is different from FIG. 20, which is the flowchart of the processing by the master control apparatus according to Embodiment 3, in that the steps S111 through S114 are replaced by the steps S115 through S117. Different parts will be explained, but the explanations for the same parts will be omitted.

In the flowchart in FIG. 22, in the step S115 after the processing by the master control apparatus 100c is started, it is determined whether or not a signal indicating the user's instruction has been inputted to the user input unit 112. In the case where there exists no user's instruction (the determination result is NO), the step S115 is followed by the step S101, where the conventional processing is performed.

In the case where in the step S115, there exists a user's instruction (the determination result is YES), the step S115 is followed by the step S116, where data in which the priority data is changed is generated. Then, the step S116 is followed by the step S117, where the priority data is processed by the master ECU or the connection ECU. In the case where the changed priority data is data whose subject is the master ECU, the priority data is sent to the priority changing unit so that the priority data of the master ECU is updated. When the changed priority data is not data whose subject is the master ECU, the priority data is sent to the priority changing unit of the corresponding connection ECU. Then, the priority data of the corresponding connection ECU is updated.

As described above, in Embodiment 4, the priority data can be changed by a user's instruction. As a result, software updating that is optimum to the user can be performed.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the specification of the present disclosure. For example, at least one of the constituent components may be modified, added, or eliminated; moreover, at least one of the constituent components mentioned in at least one of the preferred embodiments may be selected and combined with the constituent components mentioned in another preferred embodiment.

### DESCRIPTION OF REFERENCE NUMERALS

1: vehicle control apparatus
90, 190, 290: computing processing unit
91, 191, 291: storage apparatus
104, 204: priority reading unit
106, 206: updating-feasibility determination unit
108, 208: software updating unit
110: driving-situation determination unit
112: user input unit
199b: reception unit

1. A vehicle control apparatus comprising:
a computing processor;
a memory in which software items to be executed by the computing processor are written;
a priority reader that reads a priority of software to be executed by the computing processor;
a receiver that receives updating software that updates software to be executed by the computing processor;
an updating-feasibility determinator that reads, from the priority reader, a priority for software to be updated by the updating software received by the receiver and that determines that updating is feasible, in the case where the priority is larger than a predetermined priority threshold value; and
a software updater that transfers the updating software to the memory, in the case where the updating-feasibility determinator determines that updating is feasible.

2. The vehicle control apparatus according to claim 1,
wherein two or more software items are stored in the memory,
wherein the priority reader reads respective priorities determined for software items,
wherein the receiver receives a first updating software that updates a first software to be executed by the computing processor,
wherein in the case where a priority of the first software, read from the priority reader, is larger than the priority threshold value and a priority, read from the priority reader, of a second software that refers to data to be operated by the first software is the same as or smaller than the priority threshold value, the updating-feasibility determinator determines that updating is feasible, and
wherein the software updater transfers the first updating software to the memory, in the case where the updating-feasibility determinator determines that updating is feasible.

3. The vehicle control apparatus according to claim 1, wherein the updating-feasibility determinator stores the priority threshold value received by the receiver.

4. The vehicle control apparatus according to claim 1, wherein the priority reader stores a priority of the software received by the receiver.

5. The vehicle control apparatus according to claim 1, wherein the priority reader changes a priority of the software in accordance with a driving situation of a vehicle.

6. The vehicle control apparatus according to claim 1, wherein the priority reader changes a priority of the software in accordance with a driver's instruction.

7. The vehicle control apparatus according to claim 1, further comprising two or more computing processors and respective memories that are provided with the computing processors and in which respective software items to be executed by the computing processors are stored.

8. The vehicle control apparatus according to claim 2, wherein the updating-feasibility determinator stores the priority threshold value received by the receiver.

9. The vehicle control apparatus according to claim 2, wherein the priority reader stores a priority of the software received by the receiver.

10. The vehicle control apparatus according to claim 2, wherein the priority reader changes a priority of the software in accordance with a driving situation of a vehicle.

11. The vehicle control apparatus according to claim 2, wherein the priority reader changes a priority of the software in accordance with a driver's instruction.

12. The vehicle control apparatus according to claim 2, further comprising two or more computing processors and respective memories that are provided with the computing processors and in which respective software items to be executed by the computing processors are stored.

13. The vehicle control apparatus according to claim 8, wherein the priority reader stores a priority of the software received by the receiver.

14. The vehicle control apparatus according to claim 8, wherein the priority reader changes a priority of the software in accordance with a driving situation of a vehicle.

15. The vehicle control apparatus according to claim 8, wherein the priority reader changes a priority of the software in accordance with a driver's instruction.

16. The vehicle control apparatus according to claim 8, further comprising two or more computing processors and respective memories that are provided with the computing processors and in which respective software items to be executed by the computing processors are stored.

17. The vehicle control apparatus according to claim 13, wherein the priority reader changes a priority of the software in accordance with a driving situation of a vehicle.

18. The vehicle control apparatus according to claim 13, wherein the priority reader changes a priority of the software in accordance with a driver's instruction.

19. The vehicle control apparatus according to claim 13, further comprising two or more computing processors and respective memories that are provided with the computing processors and in which respective software items to be executed by the computing processors are stored.
